(19) United States
(12) Patent Application Publication
(10) Pub. No.: US 2024/0249200 A1
(43) Pub. Date: Jul. 25, 2024

(54) TIME-SERIES DATA PROCESSING DEVICE

(71) Applicant: NTT DOCOMO, INC., Tokyo (JP)

(72) Inventors: Hisashi KURASAWA, Chiyoda-ku (JP); Yoshinori ISODA, Chiyoda-ku (JP); Itsuki SHIBATA, Chiyoda-ku (JP); Hiroki ASAI, Chiyoda-ku (JP)

(73) Assignee: NTT DOCOMO, INC., Tokyo (JP)

(21) Appl. No.: 18/577,401

(22) PCT Filed: May 20, 2022
(86) PCT No.: PCT/JP2022/021017

§ 371 Date: Jan. 8, 2024

(30) Foreign Application Priority Data
Jul. 30, 2021 (JP) 2021-125359

(51) Int. Cl. G06N 20/00

(52) U.S. Cl. CPC G06N 20/00

(57) ABSTRACT

A time-series data processing device that can appropriately handle time-series data of a user action or the like in machine learning processing is provided. An action analysis device 100 includes a data processing unit 103 configured to process a plurality of pieces of time-series data indicating a user action based on time lengths associated with the time-series data and a processing unit, for example, a BERT processing unit 105, configured to perform processing associated with machine learning based on the processed plurality of pieces of time-series data. Accordingly, it is possible to process time-series data into a form appropriate for machine learning and to perform appropriate processing associated with machine learning. Examples of the processing include processing such as generation of a trained model 104a using the processed time-series data and prediction processing using the trained model 104a. A self-attention function in the trained model 104a is used herein.

### TECHNICAL FIELD

The present disclosure relates to a time-series data processing device that processes time-series data indicating a user's actions or the like.

### BACKGROUND ART

A machine learning method based on bidirectional encoder representations from transformers (BERT) of performing natural language processing is known and is described in Non Patent Literature 1. BERT performs natural language processing and image processing using an encoder/decoder model with a self-attention mechanism.

### CITATION LIST

### Patent Literature

[Non Patent Literature 1] Jacob Devlin and two others, BERT: Pre-training of Deep Bidirectional Transformers for Language Understanding, [online], published on May 24, 2019, published by arXiv.org, accessed Jul. 2, 2021, https://arxiv.org/pdf/1810.04805.pdf, English

### SUMMARY OF INVENTION

### Technical Problem

The elapse of time in each client experience or each user action is important for ascertaining the corresponding client experience or the corresponding user action. Learning of a neighborhood relationship between pieces of local or global time-series data needs to be appropriately performed based on BERT.

Therefore, in order to solve the aforementioned problem, an objective of the present disclosure is to provide a time-series data processing device that can appropriately handle time-series data of a user action or the like in machine learning processing such as BERT.

### Solution to Problem

A time-series data processing device according to the present disclosure includes: a data processing unit configured to process a plurality of pieces of time-series data indicating a user action based on time lengths associated with the time-series data; and a processing unit configured to perform processing associated with machine learning based on the processed plurality of pieces of time-series data.

### Advantageous Effects of Invention

According to the present disclosure, it is possible to generate time-series data that can be appropriately handled in processing associated with machine learning.

### BRIEF DESCRIPTION OF DRAWINGS

FIG. 1 is a diagram illustrating a system configuration of a communication system including an action analysis device 100 that acquires and analyzes a user action according to the present disclosure.

FIG. 2 is a block diagram illustrating a functional configuration of the action analysis device 100.

FIG. 3 is a diagram schematically illustrating a specific example of generalization processing.

FIG. 4 is a diagram schematically illustrating a process of inserting an action identifier.

FIG. 5 is a diagram illustrating a model schematically depicting BERT.

FIG. 6 is a flowchart illustrating learning processing that is performed by the action analysis device 100.

FIG. 7 is a flowchart illustrating process details of the action analysis device 100.

FIG. 8 is a diagram illustrating an action history database 101a.

FIG. 9 is a diagram illustrating a tabulation sheet of occurrence frequencies of categories for all users.

FIG. 10 is a diagram illustrating tabulation sheets of occurrence frequencies of hierarchically configured categories for user actions.

FIG. 11 is a diagram illustrating a merged tabulation of the tabulation sheets illustrated in FIG. 9 and FIGS. 10(a) to 10(c).

FIG. 12 is a diagram illustrating categories of 12 highest occurrence frequencies extracted from the merged tabulation sheet.

FIG. 13 is a diagram illustrating generalized action identifiers based on a management table (FIG. 12).

FIG. 14 is a diagram illustrating insertion of action identifiers indicating a break based on time intervals between actions in generalized action history data.

FIG. 15 is a diagram schematically illustrating a process of calculating and selecting a weight of attention from an action history database 101a of a user.

FIG. 16 is a diagram illustrating an example of a hardware configuration of the action analysis device 100 according to an embodiment of the present disclosure.

### DESCRIPTION OF EMBODIMENTS

An embodiment of the present disclosure will be described below with reference to the accompanying drawings. In as many cases as possible, the same elements will be referred to by the same reference signs and repeated description thereof will be omitted.

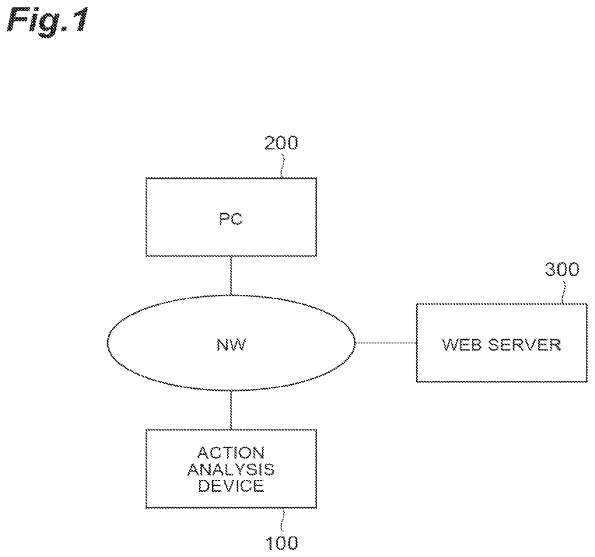

FIG. 1 is a diagram illustrating a system configuration of a communication system including an action analysis device 100 that acquires and analyzes a user action according to the present disclosure. The action analysis device 100 serves as a time-series data processing device that handles an operation history indicating that a user has accessed a web site as time-series data. When a user has used a telephone service of a certain company (such as a consultation or question about a product), the action analysis device 100 handles a state of use thereof as time-series data.

The action analysis device 100 collects and analyzes an access history indicating that a PC 200 which is operated by a user to be analyzed has accessed a web server 300. An action history of a user using a telephone service is recorded by an operator of the service and is registered in an action history database 101a of the action analysis device 100.

The PC 200 is a general personal computer and accesses the web server 300 via a network.

The web server 300 is a server that provides web information to the PC 200.

The action analysis device 100 collects action history data indicating what information of the web server 300 the PC 200 has accessed. For example, when the PC 200 has accessed a site of a mobile phone communication company, the accessed information is collected. More specifically, information on a fee plan of a mobile phone and information on a type of the mobile phone are collected.

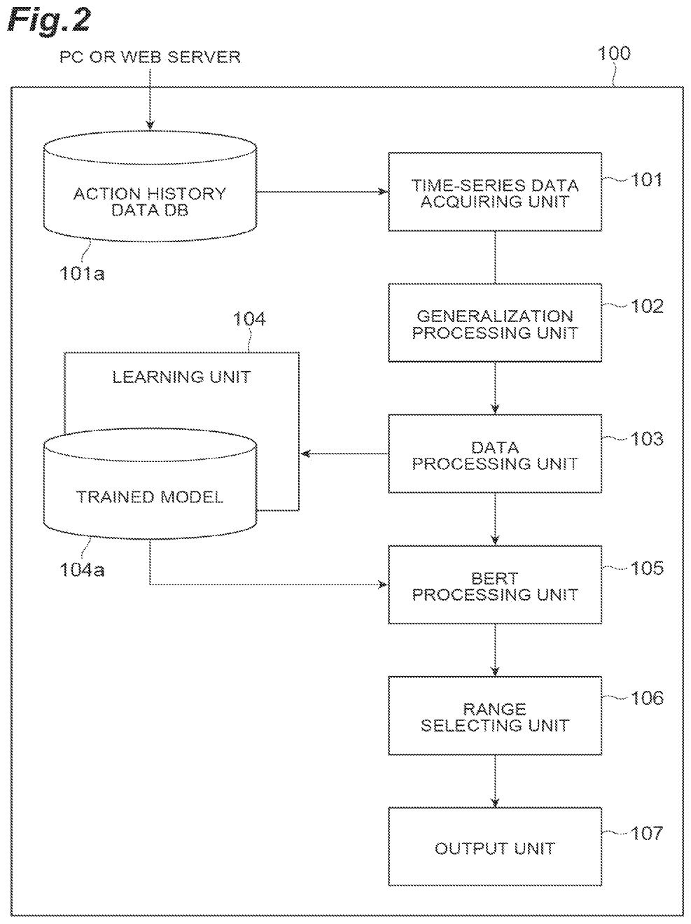

FIG. 2 is a block diagram illustrating a functional configuration of the action analysis device 100. The action analysis device 100 includes an action history database 101a, a time-series data acquiring unit 101, a generalization processing unit 102, a data processing unit 103, a learning unit 104, a trained model 104a, a BERT processing unit 105, a range selecting unit 106, and an output unit 107. These constituents will be described below.

The action history database 101a is a part that stores action history data indicating that the PC 200 has accessed the web server 300. The PC 200 or the web server 300 stores action history data in the action history database 101a with every access or periodically. The action history database 101a stores actions of a user other than an access to the web site in response to an operation of an operator as described above. In the present disclosure, when a user receives a service equivalent to the service provided by the web server 300 using a method other than using the web server 300, for example, a method using a telephone call or the like, an action of the user is registered by a telephone operator or the like. In the present disclosure, an action of a user indicates an action in response to receiving of a service when the user intends to receive the service.

The time-series data acquiring unit 101 is a part that acquires time-series data which is action history data from the action history database 101a.

The generalization processing unit 102 is a part that performs generalization processing of time-series data with a low occurrence frequency out of the acquired time-series data. For example, the generalization processing unit 102 replaces all or some of the time-series data with a low occurrence frequency with predetermined symbols or character strings as the generalization processing.

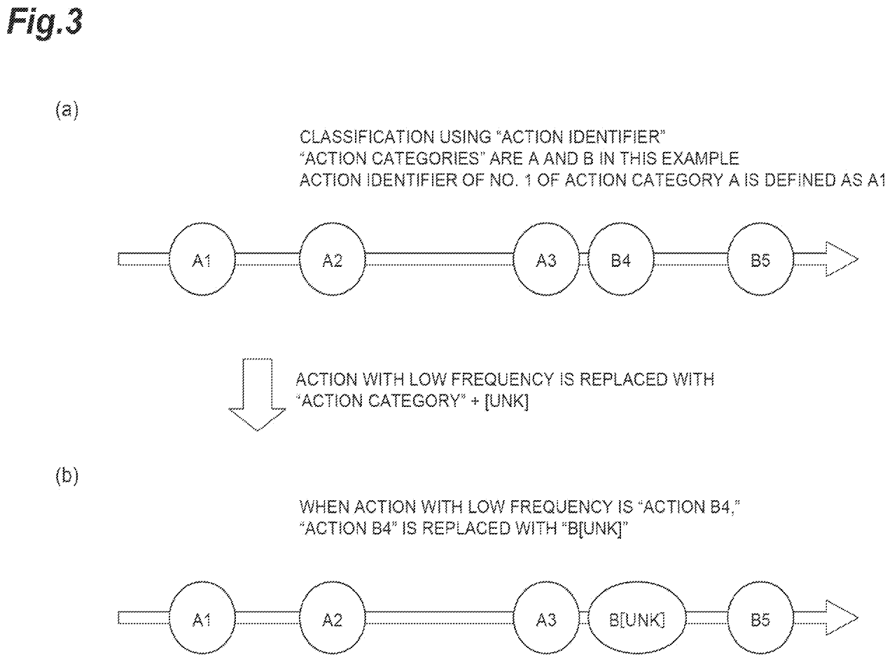

FIG. 3 is a diagram schematically illustrating a specific example of generalization processing. In the drawing, action identifiers indicated by action A1, action A2, . . . are illustrated as access information to a web site. In FIG. 3(a), a user has performed action A1, action A2 . . . , action B3, action B4, and action B5. This action A1 and the like are action identifiers and indicate an access to one piece of information in the web server 300. Action A1 and action BI represent different action categories. The generalization processing unit 102 replaces an action with a low frequency with an action category+[UNK]. For example, when an occurrence frequency of action B4 is low, the generalization processing unit 102 replaces action B4 with B[UNK] (FIG. 3(b)). More detailed processing of the generalization processing unit 102 will be described later.

The data processing unit 103 is a part that inserts an action identifier for identifying each piece of time-series data in a plurality of pieces of time-series data indicating user actions when there is a predetermined time or more between the pieces of time-series data.

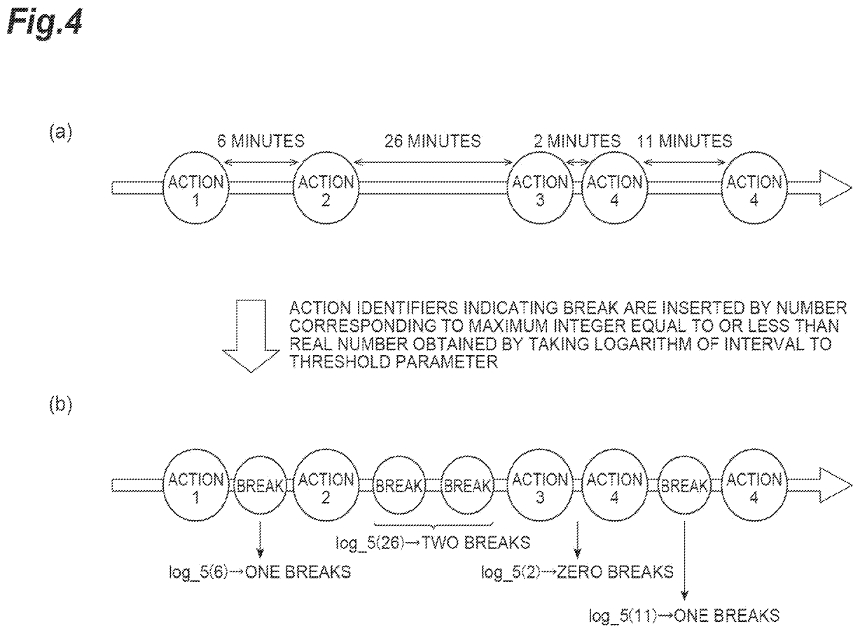

FIG. 4 is a diagram schematically illustrating a process of inserting an action identifier. In the drawing, categories are not illustrated. As illustrated in FIG. 4(a), it is assumed that there is 6 minutes between action 1 and action 2 and there is 26 minutes between action 2 and action 3. It is assumed that the other actions are as illustrated in the drawing. These actions of a user are temporally continuous and often there is no clear break. The time intervals between the actions of the user are often various.

As illustrated in FIG. 4(b), the data processing unit 103 inserts action identifiers indicating a break by a number corresponding to a maximum integer equal to or less than a real number obtained by taking a logarithm of a time interval between actions to the threshold parameter. For example, as illustrated in FIG. 4, a time interval between action 1 and action 2 is 6 minutes. When the threshold parameter is set to 5, the data processing unit 103 calculates Log₅(6)=1 and inserts an action identifier indicating a break between action 1 and action 2 between which the time interval is 6 minutes. The same calculation is performed for other actions.

By inserting an action identifier indicating a break in this way, a break between actions can be expressed. A function of taking so-called log scales such that a greater number of action identifiers indicating a break are inserted as the time interval becomes longer and the number of action identifiers is limited when the time interval becomes longer to a certain extent is used. Accordingly, a relationship between the length of the time interval and the number of action identifiers indicating a break can be expressed. In some user actions, meanings of the actions often do not change when the time elapses to a certain extent. For example, a user action performed after 5 minutes and a user action performed after 1 year need to be clearly distinguished, but a user action performed after 1 year and a user action performed after 2 years do not need to be distinguished in meaning or details of the actions.

The data processing unit 103 may insert an action identifier according to a length of a user action instead of or in addition to inserting an action identifier indicating a break. For example, when a user action is staying at home, going out, or moving, the data processing unit 103 may add an action identifier based on a length of a staying-at-home time, a going-out time, or a moving time. For example, one action identifier indicating staying at home may be added for one hour and two action identifiers may be added for two hours. An action identifier indicating the time may be added to some position before or after.

The learning unit 104 is a part that performs generalization processing and performs machine learning using processed time-series data. In the present disclosure, machine learning using a bidirectional encoder representations from transformers (BERT) used for a language model of natural language processing is performed. In BERT, learning processing is performed by performing prior learning and fine tuning. In the prior learning, blank filling question processing and neighborhood prediction processing are performed using time-series data. In normal learning based on BERT, sentences are input, but a trained model 104a based on BERT is generated by inputting time-series data subjected to generalization processing and data processing as described above in the present disclosure.

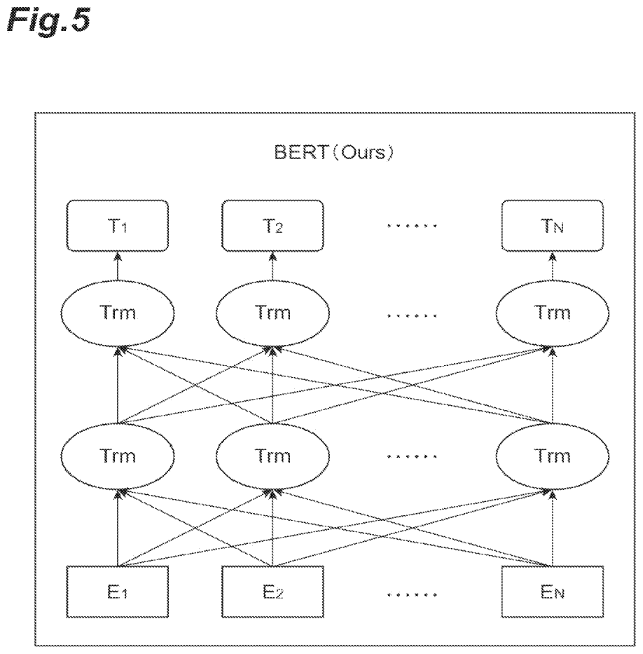

FIG. 5 is a diagram illustrating a model schematically representing BERT. This model is a model to which a vector sequence (E1, . . . , EN) is input and which outputs a vector sequence (T1, . . . , TN). The model has a structure in which a plurality of hidden layers (Trm-Transformer) are superimposed between an input layer and an output layer. The drawing has been extracted from Non Patent Literature 1.

The BERT processing unit 105 is a part that performs processing using the trained model 104a based on BERT. The BERT processing unit 105 calculates weights of attention indicating degrees of association between a plurality of input pieces of time-series data using a self-attention function of the trained model 104a based on BERT. The learning unit 104 trains the trained model 104a to calculate the weights of attention.

The range selecting unit 106 is a part that derives an action associated with a designated user action based on the weights of attention calculated by the BERT processing unit 105. The range selecting unit 106 receives time-series data to be compared, compares the weights of attention between the time-series data to be compared with a threshold value input in advance, and selects time-series data with a weight of attention equal to or greater than the threshold value. The range selecting unit 106 may select time-series data subsequent to the oldest time-series data. In this case, the selected time-series data may include time-series data with a weight of attention less than the threshold value.

The output unit 107 is a part that outputs the selected time-series data. In the present disclosure, the output unit 107 performs outputting to a display unit or outputting to the outside via a communication unit.

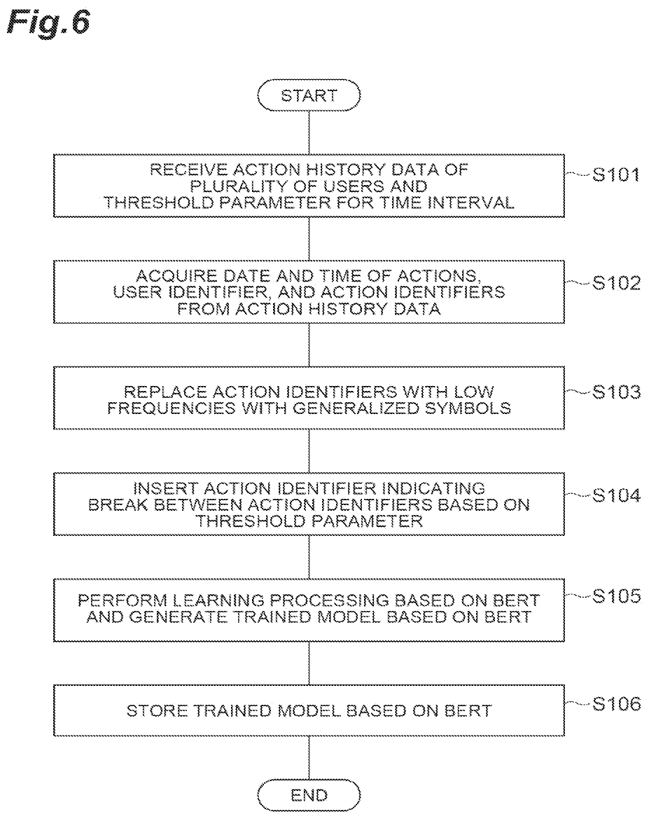

The operation of the action analysis device 100 according to the present disclosure will be described below. FIG. 6 is a flowchart illustrating learning processing which is performed by the action analysis device 100.

The time-series data acquiring unit 101 receives action history data of a plurality of users and a threshold parameters of time intervals (S101). Then, the time-series data acquiring unit 101 acquires date and time of an action, a user identifier, and an action identifier from the action history data (S102).

The generalization processing unit 102 sorts action identifiers acquired for each user based on the user identifiers and performs generalization processing on an action identifier with a low occurrence frequency out of the action identifiers for each user. That is, the generalization processing unit 102 replaces the action identifier with a low frequency with a generalized symbol (S103).

The data processing unit 103 inserts an action identifier indicating a break between action identifiers based on the threshold parameters (S104). This processing is performed on, for example, 1000 pieces of time-series data.

The learning unit 104 performs learning processing using BERT and generates and stores a trained model 104a based on BERT (S105 and S106). For example, learning processing using 1000 pieces of time-series data is performed.

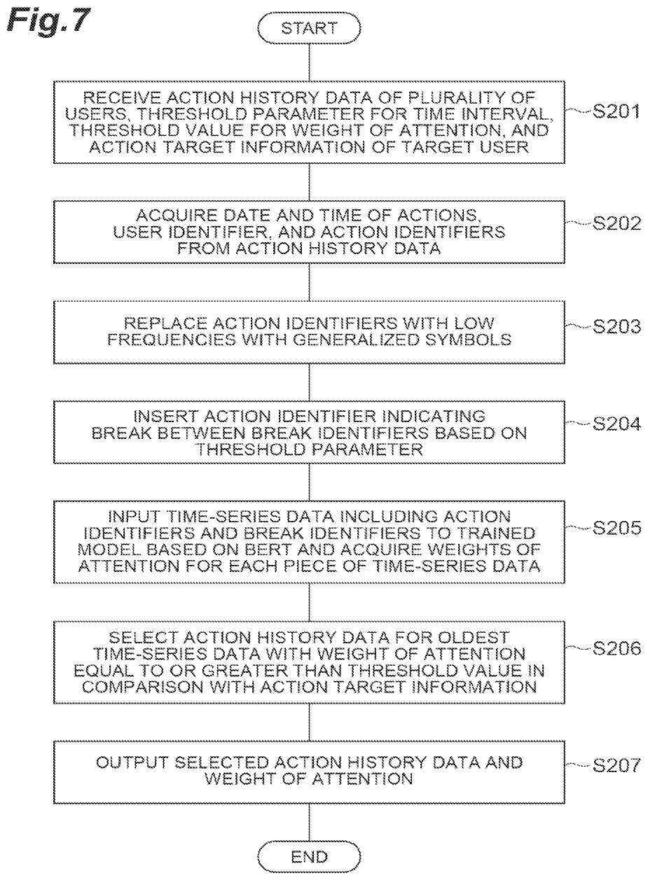

Processing using a trained model 104a based on BERT will be described below. Here, processing of identifying another action associated with a designated user action using a self-attention function of the trained model 104a will be described. FIG. 7 is a flowchart illustrating processing details which are performed by the action analysis device 100.

Processes S201 to S204 are substantially the same as processes S101 to S104. That is, the time-series data acquiring unit 101 in the action analysis device 100 acquires action history data of users and a threshold parameter. The time-series data acquiring unit 101 additionally acquires a threshold value for a weight of attention and action target information of a user to be compared. Then, the time-series data acquiring unit 101 acquires action identifiers or the like as time-series data from the action history data, the generalization processing unit 102 performs generalization processing, and the data processing unit 103 inserts an action identifier indicating a break into a position at which a predetermined condition is satisfied in the time-series data.

The BERT processing unit 105 inputs time-series data including an action identifier and a break identifier to the trained model 104a and acquires a weight of attention for each piece of time-series data (S205).

The range selecting unit 106 selects action history data corresponding to time-series data of a user designated in advance from all pieces of time-series data based on the weight of attention for each combination of time-series data and the threshold value for the weight of attention received in advance (S206). That is, the range selecting unit 106 selects time-series data (action history data) with a weight of attention equal to or greater than the threshold value out of the action target information (time-series data) to be compared which has been received in Process S201 and the weights of attention of the time-series data.

The output unit 107 outputs the selected time-series data (action history data) and the weight of attention thereof (S207).

In this way, it is possible to select another action history data associated with the action target information.

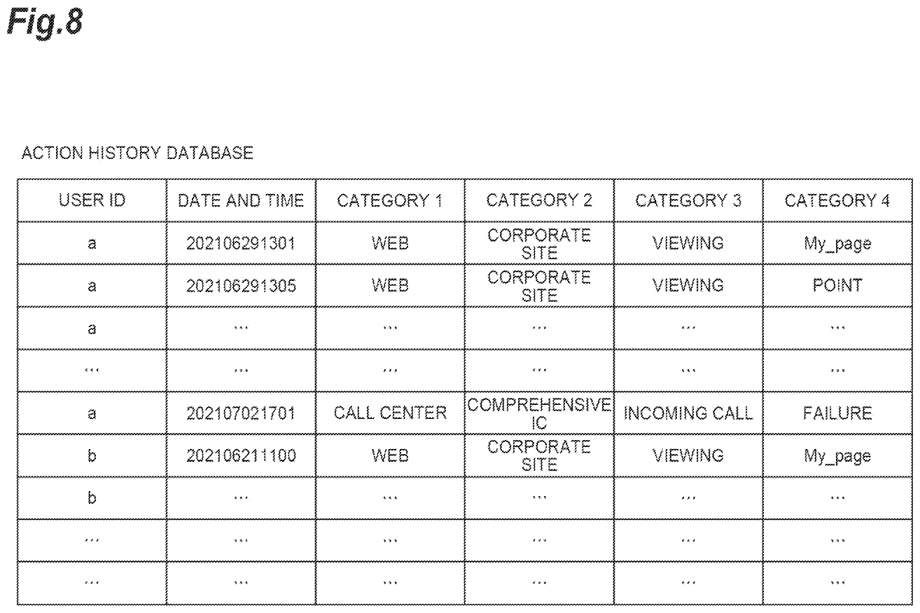

Generalization processing will be described below with reference to FIGS. 8 to 11. FIG. 8 is a diagram illustrating the action history database 101a. As illustrated in the drawing, the action history database 101a correlates a user ID, a date and time, and categories 1 to 4. The user ID is an identifier for identifying a user. The date and time indicates a date and time at which the user performed an action. In the drawing, a date and a time are illustrated, but only a date may be illustrated. Categories 1 to 4 indicate categories into which user actions are classified. Category 1 indicates a web access or a call to a call center. Category 2 indicates a category such as a corporate site, an online procedure (OLT), or a comprehensive information center (IC). Category 3 indicates a category such as web viewing or incoming call. Category 4 indicates a category of a specific example of a user action. In the drawing, an access to My_Page, an access to a point page, and the like are illustrated.

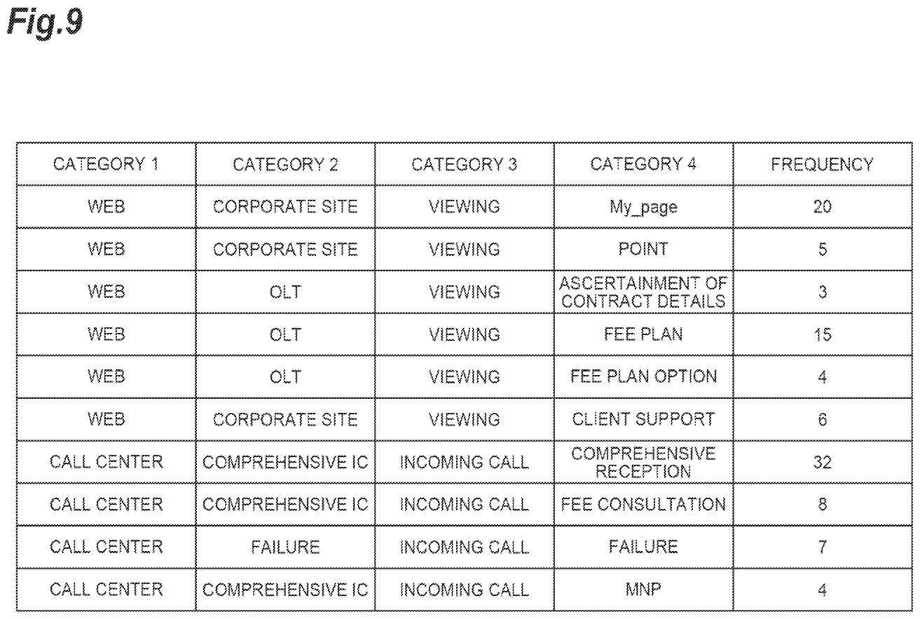

FIG. 9 is a diagram illustrating a tabulation sheet of occurrence frequencies for each category of action history data in a predetermined period for all users. For example, the drawing illustrates that category 1 is web, category 2 is a corporate site, category 3 is viewing, and category 4 is that a frequency of an action in My_Page is 20. This frequency is information collected from action histories of users described in the action history database 101a. In the present disclosure, the generalization processing unit 102 performs a process of collecting a frequency of each category when performing generalization processing on time-series data.

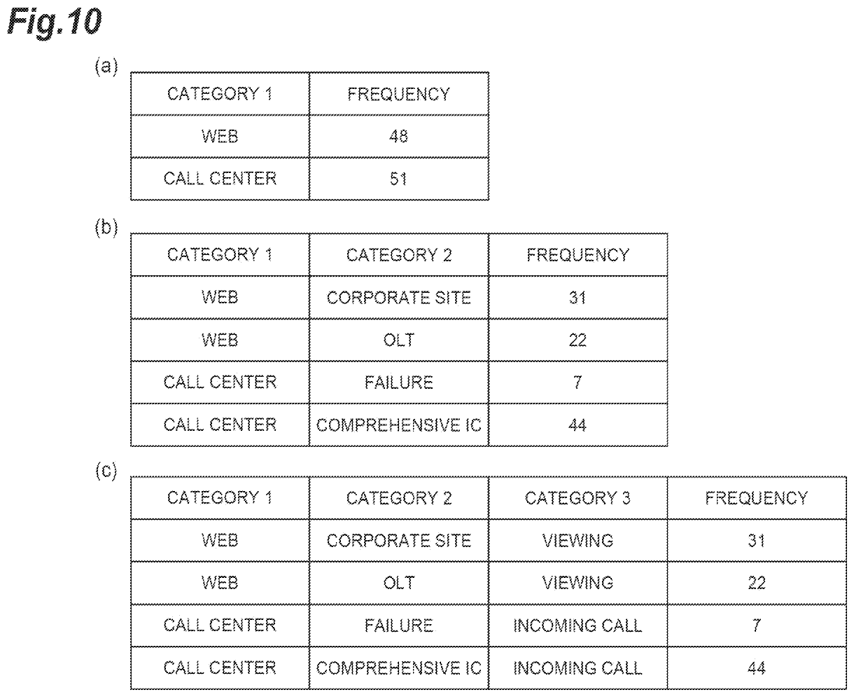

FIG. 10 is a diagram illustrating a tabulation sheet of frequencies of categories of user actions in which the categories are hierarchically classified. That is, frequencies of user actions are collected for each large category, each middle category, and each small category. In the present disclosure, categories are divided into categories 1 to 4. Category 1 indicates a category with a highest concept of user actions. Categories 2 to 4 are defined such that the concept is narrowed as the numerical value thereof increases.

FIG. 10(a) is a diagram illustrating a tabulation sheet of frequencies of user actions included in category 1. Category 1 is a category including categories 2 to 4. As illustrated in the drawing, frequencies of user actions classified into the categories indicating whether a user has used a web or a call center are counted.

FIG. 10(b) is a diagram illustrating a tabulation sheet of frequencies of user actions included in category 2. Category 2 is a category including categories 3 and 4. For example, category 2 indicates a tabulation of frequencies of an access to a corporate site and frequencies of an access to OLT.

FIG. 10(c) is a diagram illustrating a tabulation sheet of frequencies of user actions included in category 3.

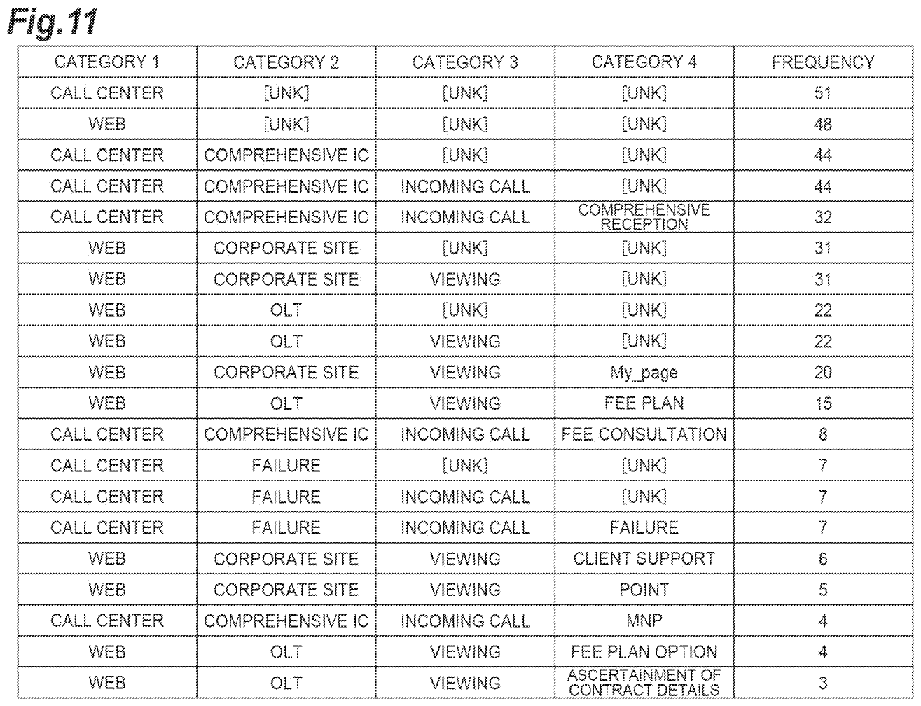

FIG. 11 is a diagram illustrating a merged tabulation of the tabulation sheets illustrated in FIG. 9 and FIGS. 10(a) to 10(c). In FIG. 11, categories are arranged in the descending order of frequencies after being merged. In the present disclosure, categories with the same frequency are classified with a category including a large category as a higher rank. In the frequencies classified into a large category, entries of a middle category and a small category are missing. In the missing parts, a character string [UNK] indicating general information is described. A character string other than [UNK] may be used. Another symbol may be used as long as it is a character string or a symbol indicating general information.

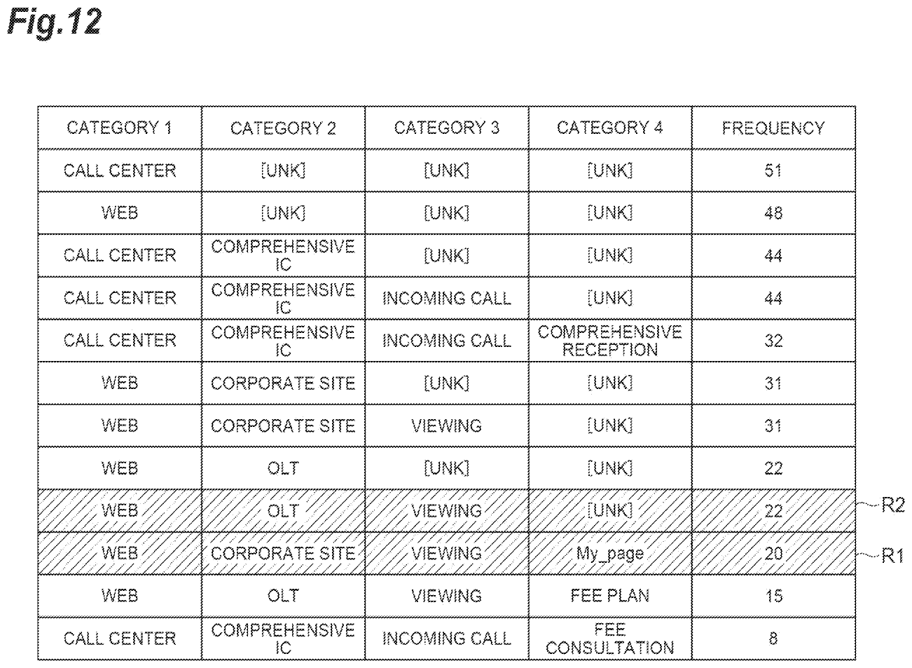

FIG. 12 is a diagram illustrating categories of 12 highest occurrence frequencies extracted from the merged tabulation sheet illustrated in FIG. 11. In the present disclosure, this table is referred to as a management table. The management table is not limited to 12 frequencies and may be set to an arbitrary value.

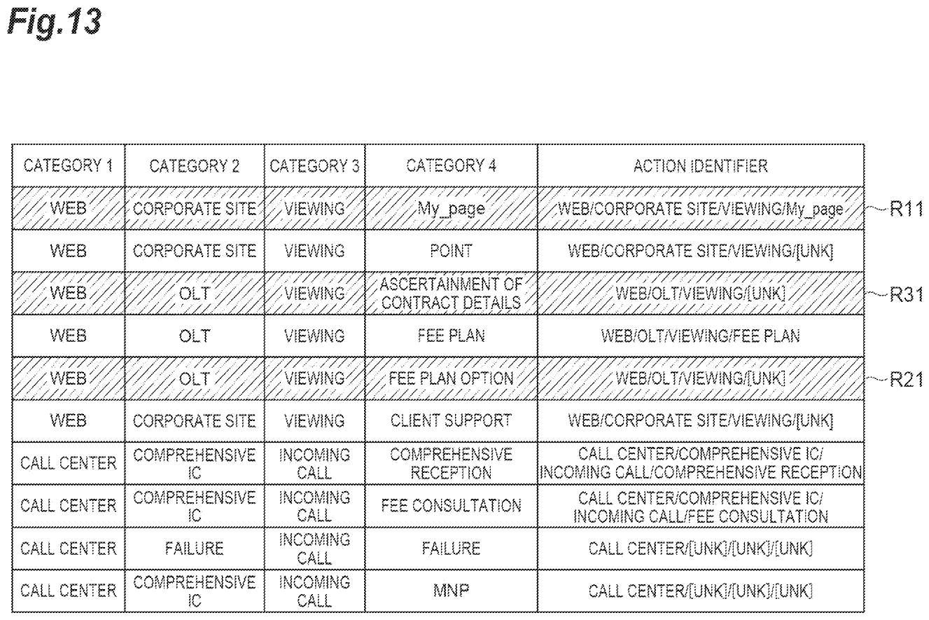

FIG. 13 is a diagram illustrating generalized action identifiers based on the management table (FIG. 12). The generalization processing unit 102 searches for action history records corresponding to the categories described in the management table from the action history database 101a. Categories in each corresponding action history record are connected by “/” to generate an action identifier. The generalization processing unit 102 replaces a non-corresponding low-ranked category with [UNK] in the action history records of which high-ranked categories match but low-ranked categories do not match. Then, the generalization processing unit 102 connects the categories by “/” to generate an action identifier.

For example, when record R1 (category 1: web, category 2: corporate site, category 3: viewing, category 4: My_Page) described in the management table is also described in the action history database 101a, an action identifier is generated based thereon.

On the other hand, for example, when categories 1 to 3 in record R2 (category 1: web, category 2: OLT, category 3: viewing, category 4: [UNK]) described in the management table are also described in the action history database 101a, an action identifier is generated using category 4: [UNK] regardless of details of category 4. In FIG. 13, web/OLT/viewing/[UNK] is generated as an action identifier of action history record R2 (see record R21). In record R21, “fee plan option” is registered as category 4, the frequency of access to this entry is low, and thus generalization processing is performed. Web/OLT/viewing out of the action identifier web/OLT/viewing/[UNK] corresponds to an action category.

In this way, when individual occurrence frequencies are low in comparison with all the occurrence frequencies, generalization processing is performed using a character string [UNK]. In FIG. 13, an action identifier of record R31 (category 1: web, category 2: OLT, category 3: viewing, category 4: ascertainment of contract details) is web/OLT/viewing/[UNK] which is the same as the action identifier of record R21. Record R21 and record R31 are handled as the same action from the viewpoint of the whole user actions.

When a degree of association is calculated in an encoder model with attention such as BERT, they are handled as the same action. Accordingly, it is possible to reduce a calculation processing load for calculating a weight of attention.

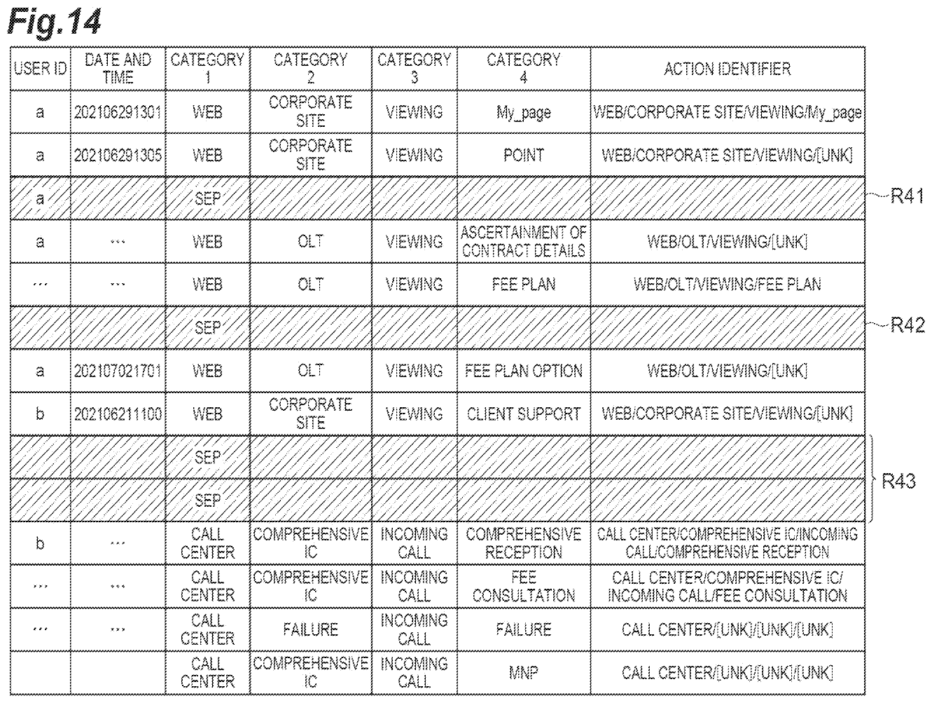

FIG. 14 is a diagram illustrating insertion of action identifiers indicating a break based on time intervals between actions in generalized action history data.

As illustrated in the drawing, records R41 to R43 are inserted between user actions. Records R41 to R43 indicate action identifiers indicating a break illustrated in FIG. 4. In FIG. 14, a break is expressed by inserting “SEP.” Accordingly, it is possible to easily ascertain a neighborhood relationship between user actions. That is, when a time interval is short, it is thought that there is a close relationship between neighboring actions. On the other hand, when a time interval is long, it is though that there is not such a relationship between the neighboring actions. According to the present disclosure, it is possible to clarify association between neighboring actions.

Insertion of an action identifier indicating a break illustrated in FIG. 14 is performed on action history data acquired by the time-series data acquiring unit 101, and learning processing based on BERT is performed thereon by the learning unit 104.

The time-series data acquiring unit 101 acquires, for example, 1000 pieces of action history data as time-series data from the whole action history data. The generalization processing unit 102 and the data processing unit 103 perform the generalization processing and the process of inserting an action identifier indicating a break on the 1000 pieces of action history data.

The learning unit 104 performs blank filling question processing and neighborhood prediction processing on the resultant time-series data. The blank filling question processing is performed by randomly masking records of one or more pieces of time-series data. The neighborhood prediction processing is performed by performing neighborhood prediction of records. In this way, the trained model 104a is trained.

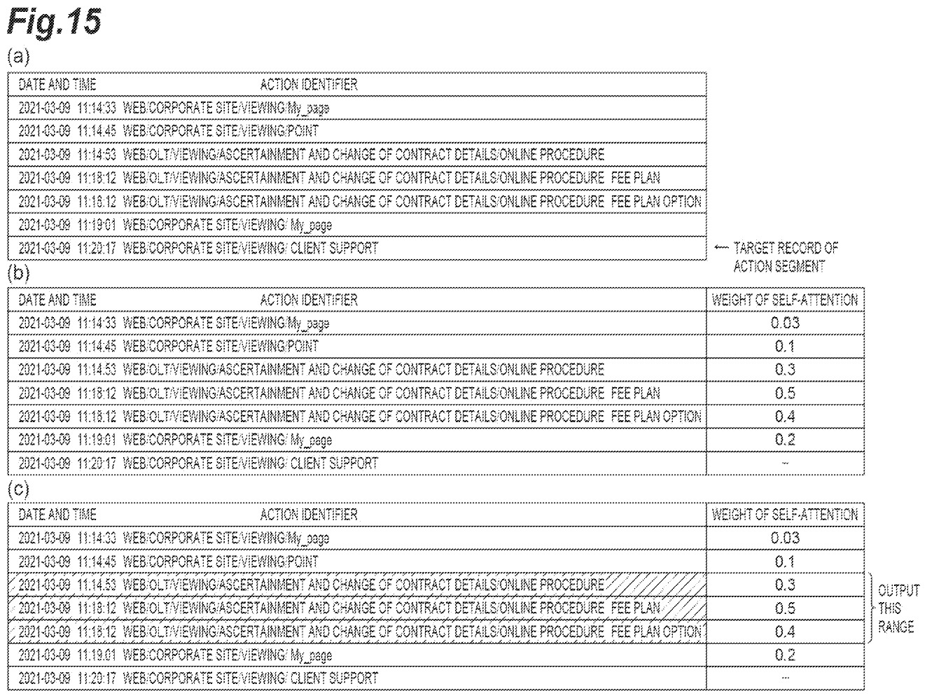

FIG. 15 is a diagram schematically illustrating a process of calculating and selecting a weight of attention from the action history database 101a of a user. In FIG. 15(a), date and times at which actions have occurred and action identifiers are illustrated for the purpose of convenience. Records which are action segment targets (action target information) as illustrated in FIG. 4 are designated in advance by an operator.

FIG. 15(b) is a diagram illustrating correlation of a weight of self-attention which is calculated based on a self-attention mechanism by the BERT processing unit 105. In the drawing, an action identifier web/corporate site/viewing/client support is designated as an action segment target. A degree of association therewith is expressed by a weight of self-attention.

FIG. 15(c) is a diagram illustrating a range which is selected by the range selecting unit 106 when a threshold value of the weight of self-attention is 0.3. An action identifier with a weight of self-attention equal to or greater than 0.3 is selected. In the present disclosure, an action identifier with a weight of self-attention equal to or greater than 0.3 is selected, but the present disclosure is not limited thereto and an action identifier which has occurred after the oldest action identifier out of the action identifiers with a weight of self-attention equal to or greater than 0.3 may be selected.

Operations and advantages of the action analysis device 100 according to the present disclosure will be described below. The action analysis device 100 according to the present disclosure serves as a data processing device that processes time-series data into a form appropriate for machine learning.

The action analysis device 100 according to the present disclosure includes a data processing unit 103 configured to process a plurality of pieces of time-series data indicating a user action based on time lengths associated with the time-series data and a processing unit, for example, a BERT processing unit 105, configured to perform processing associated with machine learning based on the processed plurality of pieces of time-series data.

Accordingly, it is possible to process time-series data into a form appropriate for machine learning and to perform appropriate processing associated with machine learning. Examples of the processing include generation of a trained model 104a using the processed time-series data and prediction using the trained model 104a. In the present disclosure, a self-attention function of the trained model 104a is used.

Here, the data processing unit 103 performs processing by inserting an action identifier indicating a break between the pieces of time-series data based on time intervals between the pieces of time-series data. The data processing unit 103 may insert action identifiers of a number corresponding to lengths of the time intervals. The number may be a number based on values obtained by taking logarithms of the time intervals between time-series data to a predetermined value. A function or another method which is defined such that the number of insertion positions to be added decreases according to the lengths of the time intervals can be used. An upper limit of the number of insertion positions may be determined, or the same number of insertion positions may be used when time intervals equal to or greater than a certain value are empty.

The data processing unit 103 may process the time-series data based on time lengths of user actions indicated by the time-series data. For example, the data processing unit 103 may add identifiers indicating the time lengths or identifiers (copied action identifiers) indicating the actions to the time-series data according to the time lengths of the actions indicated by the time-series data.

With this configuration, it is possible to generate time-series data according to a length of a user action such as a staying-at-home time, a going-out time, or a moving time. It is possible to process the time-series data into a form appropriate for machine learning and to perform appropriate processing associated with machine learning. For example, when the staying-at-home time is long, it may be expressed by copying the time-series data indicating staying at home. In this case, a logarithmic function may be used to adjust the number of copies.

The BERT processing unit 105 calculates weights of attention of the pieces of time-series data based on the self-attention function and acquires one or more other pieces of time-series data with a high degree of association with arbitrary time-series data based on the weights of attention.

With this configuration, it is possible to calculate time-series data with a high degree of association using the self-attention function of a trained model obtained by performing learning processing in a data form appropriate for the time-series data.

The BERT processing unit 105 acquires time-series data which has occurred after another piece of time-series data satisfying a predetermined condition out of other pieces of time-series data with a weight of attention equal to or greater than a predetermined value.

With this configuration, time-series data after time-series data with a high degree of association has occurred is handled as data with a high degree of association. Time-series data with a low degree of association may be included therein, but the time-series data have a certain degree of association because it is time-series data surrounded with the time-series data with a high degree of association. This time-series data can also be included.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

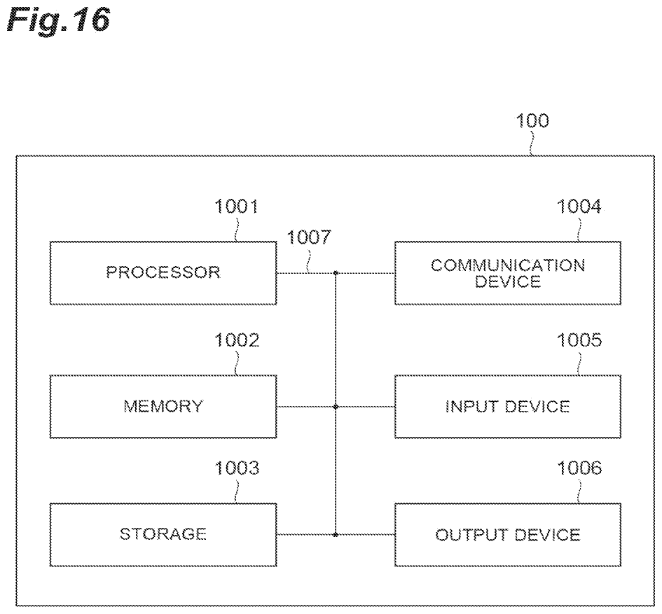

For example, the action analysis device 100 and the like according to one embodiment of the present disclosure may function as a computer that performs processing of a action analysis method or a conversation information generation method according to the present disclosure. FIG. 16 is a view showing an example of the hardware configuration of the action analysis device 100 according to one embodiment of the present disclosure. The action analysis device 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the action analysis device 100 may be configured to include one or a plurality of the devices shown in the drawings or may be configured without including some of those devices.

The functions of the action analysis device 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the generalization processing unit 102, the data processing unit 103 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, he generalization processing unit 102 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (Erasable Programmable ROM), EEPROM (Electrically Erasable Programmable ROM), RAM (Random Access Memory) and the like, for example. The memory 1002 may be also called a register, a cache, a main memory (main storage device) or the like. The memory 1002 can store a program (program code), a software module and the like that can be executed for implementing a action analysis device method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described output unit 107 or the like may be implemented by the communication device 1004.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the action analysis device 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure e may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middle ware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning.

Further, information, parameters and the like described in the present disclosure may be represented by an absolute value, a relative value to a specified value, or corresponding different information. For example, radio resources may be indicated by an index.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a micro wave region and an optical (both visible and invisible) region.

The description “on the basis of” used in the present disclosure does not mean “only on the basis of” unless otherwise note d. In other words, the description “on the basis of” means both of “only on the basis of” and “at least on the basis of”.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 . . . Action analysis device
200 . . . PC
300 . . . Web server
101a . . . Action history database
101 . . . Time-series data acquiring unit
102 . . . Generalization unit
103 . . . Data processing unit
104 . . . Learning unit
104a . . . Trained model
105 . . . BERT processing unit
106 . . . Range selecting unit
107 . . . Output unit

1. A time-series data processing device comprising:
a data processing unit configured to process a plurality of pieces of time-series data indicating a user action based on time lengths associated with the time-series data; and
a processing unit configured to perform processing associated with machine learning based on the processed plurality of pieces of time-series data.

2. The time-series data processing device according to claim 1, wherein the data processing unit inserts an action identifier indicating a break between the pieces of time-series data based on time intervals between the pieces of time-series data.

3. The time-series data processing device according to claim 2, wherein the data processing unit inserts action identifiers of a number corresponding to lengths of the time intervals.

4. The time-series data processing device according to claim 3, wherein the data processing unit performs insertion processing which is defined such that the number of insertion positions to be added decreases according to the lengths of the time intervals.

5. The time-series data processing device according to claim 4, wherein the data processing unit inserts action identifiers of a number based on values obtained by taking logarithms of the time intervals to a predetermined value.

6. The time-series data processing device according to claim 1, wherein the data processing unit processes the time-series data based on time lengths of actions of a user indicated by the time-series data.

7. The time-series data processing device according to claim 6, wherein the data processing unit adds identifiers indicating the time lengths or identifiers indicating the actions to the time-series data according to the time lengths of the actions indicated by the time-series data.

8. The time-series data processing device according to claim 1, wherein the processing unit performs processing associated with machine learning on the time-series data.

9. The time-series data processing device according to claim 8, wherein the processing unit calculates weights of attention of the pieces of time-series data based on a self-attention function, and
wherein the processing unit acquires one or more other pieces of time-series data with a high degree of association with arbitrary time-series data based on the weights of attention.

10. The time-series data processing device according to claim 9, wherein the processing unit identifies another piece of time-series data with the elapse of predetermined time out of the other pieces of time-series data of which the degree of association is determined to be high based on the weights of attention, and
wherein the processing unit acquires one or more pieces of time-series data generated after the other piece of time-series data.

11. The time-series data processing device according to claim 2, wherein the processing unit performs processing associated with machine learning on the time-series data.

12. The time-series data processing device according to claim 2, wherein the processing unit performs processing associated with machine learning on the time-series data.

13. The time-series data processing device according to claim 3, wherein the processing unit performs processing associated with machine learning on the time-series data.

14. The time-series data processing device according to claim 4, wherein the processing unit performs processing associated with machine learning on the time-series data.

15. The time-series data processing device according to claim 5, wherein the processing unit performs processing associated with machine learning on the time-series data.

16. The time-series data processing device according to claim 6, wherein the processing unit performs processing associated with machine learning on the time-series data.

17. The time-series data processing device according to claim 7, wherein the processing unit performs processing associated with machine learning on the time-series data.
